(19) United States
(12) Patent Application Publication
(10) Pub. No.: US 2010/0080087 A1
(43) Pub. Date: Apr. 1, 2010

(54) Multifunction Sports and Recreation Device

(76) Inventor: William A. Shupp, The Woodlands, TX (US)

Correspondence Address: Law Offices of Tim Headley, 7941 Katy Fwy, Suite 506, Houston, TX, 77024-1924, US

(21) Appl. No.: 12/632,288

(22) Filed: Dec. 7, 2009

Related U.S. Application Data
(63) Continuation-in-part of application No. 12/075,308, filed on Mar. 10, 2008, now abandoned.

(51) Int. Cl. G04B 47/06; G10K 5/00; G01C 17/00

(52) U.S. Cl. 368/14; 116/137 R; 33/355 R

(57) ABSTRACT

A multifunction sports and recreation device includes a sports whistle, a detachable measuring lanyard, a laser pointer, and a multimode digital electronic stopwatch that displays date, time, and advanced stopwatch information, with daily and segmented alarms. The device is also capable of displaying temperature, relative humidity, and heat index information (along with a heat index alarm). In other embodiments, particularly those with an outdoor recreation influence, the device includes a digital compass; radio frequency transmitters and receivers for locating a base camp; and means for monitoring or indicating wind speed, barometric pressure, and lunar tide cycles. The device may also incorporate an outdoor light and fire-starting flint.

### CROSS-REFERENCES TO RELATED APPLICATIONS

This patent application is a continuation-in-part of Ser. No. 12/075,308, filed Mar. 10, 2008, and thus claims the benefit of that filing date.

### STATEMENT REGARDING FEDERALLY SPONSORED RESEARCH OR DEVELOPMENT

None.

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC

None.

### BACKGROUND OF THE INVENTION

(1) Field of the Invention

This invention relates generally to handheld sports and recreation devices that incorporate various functions useful for both sports and recreation.

(2) Description of the Related Art

Athletic coaches typically wear a whistle attached to a lanyard which is worn around the neck. When a coach wishes to signal a command to athletes during practice, he grasps the whistle in his hand, raises it to his lips, and blows into it. The whistle provides a distinct and recognizable shrill which directs the athletes to begin or conclude some activity.

Although whistles have been in existence for quite some time, there tend to be disadvantages associated with various designs. There is an ever-increasing need for high quality whistles. Such whistles are usually be of a well-known shape which may be referred to as a flat-topped “mandolin” shape in side elevation, and may utilize a ball or pea. A well-known disadvantage associated with pea whistles is that loss of sound can occur by “over-blowing”, or when the usually freely-moving pea sticks to saliva in the whistle. Thus, attempts have been made to generally reproduce the loud piercing sound of a pea whistle without incurring the disadvantages of a pea whistle.

In addition to a whistle, coaches also carry various stopwatches or hand-timers to measure an athlete's performance, particularly during track and field events or when running a team sports practice like football. A coach often needs a timing device that functions as a chronograph: that records, stores, and recalls split times and lap times; that has a countdown timer with interval repeats; and that includes daily alarms and segment alarms to allow for timing of individualized activities. For example, it is helpful to be able to set multiple segment alarms to indicate when one drill should end, and another should begin (and end), as well as keep informed of time and date. The ability to easily use and program such a watch is important.

From time to time, coaches are also called upon to measure certain distances, such as splits between linemen in football, vertical leaps of players in basketball, and the like. Absent carrying a bulky tape measure, yardstick, or other fixed or variable measuring device, a coach often finds himself estimating such lengths with mixed results. A measuring device that is easy to carry and use would be very helpful for coaches.

While studying video tapes of practice sessions or the game tapes of upcoming opponents, coaches often need to use a laser pointer to indicate a particular formation, offensive or defensive alignment, or a player's individual technique. Carrying a laser pointer in a shirt or pant pocket can be problematic, because laser pointers can often break or become easily lost. Hanging the laser pointer around the coach's neck with a lanyard, along with his whistle lanyard and stopwatch lanyard, is also not desired.

Coaches need to be cognizant of practice or playing conditions, particularly in hot-weather environments. Athletes who participate in sports or are physically active in hot weather can be at risk for heat-related illnesses. Each year in the United States, there are a number of tragic stories about athletes who lose their lives after playing or practicing in the heat. Coaches need to be aware of temperature and humidity levels in order to adapt or change practice length, activity intensity, and equipment as the. temperature rises. They also need to know when to offer more frequent water and drink breaks as the temperature and humidity levels rise.

Nowadays, local broadcast weather reports and online weather sites include information about outside temperatures and the “heat index” (sometimes referred to as the “apparent temperature”). The heat index is an accurate measure of how hot it really feels when the relative humidity is added to the actual air temperature. A sports device that monitors and displays temperature, relative humidity, and heat index information on a real-time or near real-time basis would be helpful.

A coach could be called upon to carry a sports whistle, a stopwatch, a tape measure, a temperature and humidity measuring device, a laser pointer, and also a clip-board, to record certain times or events. One can imagine how burdensome it would be to have all of these items hanging around a coach's neck, filing his pockets, or carried in his arms. As such, being able to combine all of these items into one small, easily carried, integrated, multifunction sports and recreation device would be very useful.

Although the foregoing has focused on the needs of coaches, it is clear that other persons in other settings would benefit from a device that features these functions and others. For example, whistles are often packed in survival kits for hikers, campers, boaters, or other outdoor enthusiasts to allow a victim to signal for help. Likewise, these same people benefit from carrying a stopwatch or other timing device to track the duration of hikes, the amount of time water skiing behind a boat, or other activities. In a recreational setting, it would also be helpful to have a measuring device to measure such things as the length of a fish or the circumference of a tree trunk. And, of course, being able to have temperature, relative humidity, and heat index readings in an integrated, easily carried device would be extremely useful for those spending long times outdoors.

Hikers, campers, and boaters also carry various navigational instruments such as a compass or homing beacon. The face of a compass generally highlights the cardinal points of north, south, east, and west, providing a navigation capability. A homing beacon is a device that allows the user to track a ship, an animal, or another individual, or may be otherwise employed by hikers, campers, hunters, boaters, and other sportsmen in the wilderness to maintain their bearings and insure against the possibility of becoming lost. Unfortunately, popular homing beacons, such as those that rely on global positioning systems, can be difficult to use, or too cost-prohibitive to buy.

Recreation enthusiasts would profit from having (1) a small light for illumination in the dark, and (2) a flint stick for starting fires outdoors. In addition to these functions, a recreation enthusiast may also rely on devices that monitor or display wind speed, barometric pressure, and lunar tide cycles. Combining all of these features into one multifunction sports and recreation device would be helpful and useful.

Accordingly, there is a need for an improved sports and recreation device that incorporates a sports whistle, a measuring device, a laser pointer, a multimode digital electronic stopwatch that displays date, time, and stopwatch information, with daily and segmented alarms, an indicator of temperature, relative humidity, and heat index (along with a heat index alarm), a digital compass; radio frequency transmitters and receivers for locating a base camp, means for monitoring or indicating wind speed, barometric pressure, and lunar tide cycles; and an outdoor light and fire-starting flint.

### BRIEF SUMMARY OF THE INVENTION

The multifunction sports and recreation device of the present invention includes in a single housing a sports whistle, a detachable measuring lanyard, a laser pointer, a multimode digital electronic stopwatch that displays date, time, and advanced stopwatch information, with daily and segmented alarms, and an indicator of temperature, relative humidity, and heat index information (along with a heat index alarm). In other embodiments, the device includes a digital compass, radio frequency transmitters and receivers for locating a base camp, means for monitoring or indicating wind speed, barometric pressure, and lunar tide cycles, an outdoor light, and a fire-starting flint.

### BRIEF DESCRIPTION OF THE SEVERAL VIEWS OF THE DRAWINGS

FIG. 1 is a view of the multifunction sports and recreation device of the present invention, hanging around the neck of a person, using an attached lanyard;

FIG. 2A is a perspective view of the multifunction sports and recreation device of the present invention, including the detached lanyard, functioning as a laser pointer;

FIG. 2B is a perspective view of the multifunction sports and recreation device of the present invention, including the attached lanyard;

FIG. 3A is a side view of the component parts of the multifunction sports and recreation device, showing the plug-in attachment for the lanyard as attached;

FIG. 3B is a side view of the component parts of the multifunction sports and recreation device, showing the plug-in attachment for the lanyard as detached;

FIG. 4A is a perspective view of the top of the outside of the device housing;

FIG. 4B is a perspective view of the bottom of the outside of the device housing;

FIGS. 5A and 5B are end views of each end of the device;

FIGS. 6A and 6B are views of each side of the lanyard attached to the device;

FIG. 7 is an exploded perspective view of the multifunction sports and recreation device.

FIG. 8 is a cut-away view of the device, showing the extensions of the buttons, and the space for the PCB board.

FIG. 9 is a partial interior view of the device, showing the connections of the PCB board, the laser diode, and the spring clip.

FIGS. 10A-10S are views of the LCD screen, showing the various modes of the watch, stopwatch, timer, heat index indicator.

### DETAILED DESCRIPTION OF THE INVENTION

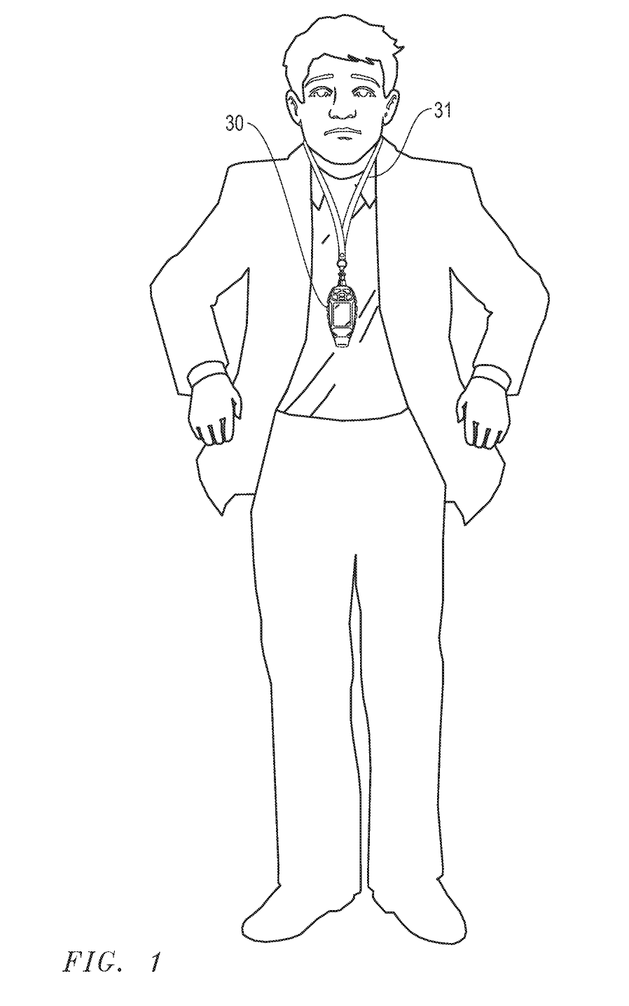

In FIG. 1, a multifunction sports and recreation device 30 of the present invention hangs around the neck of a person, using an attached lanyard 31.

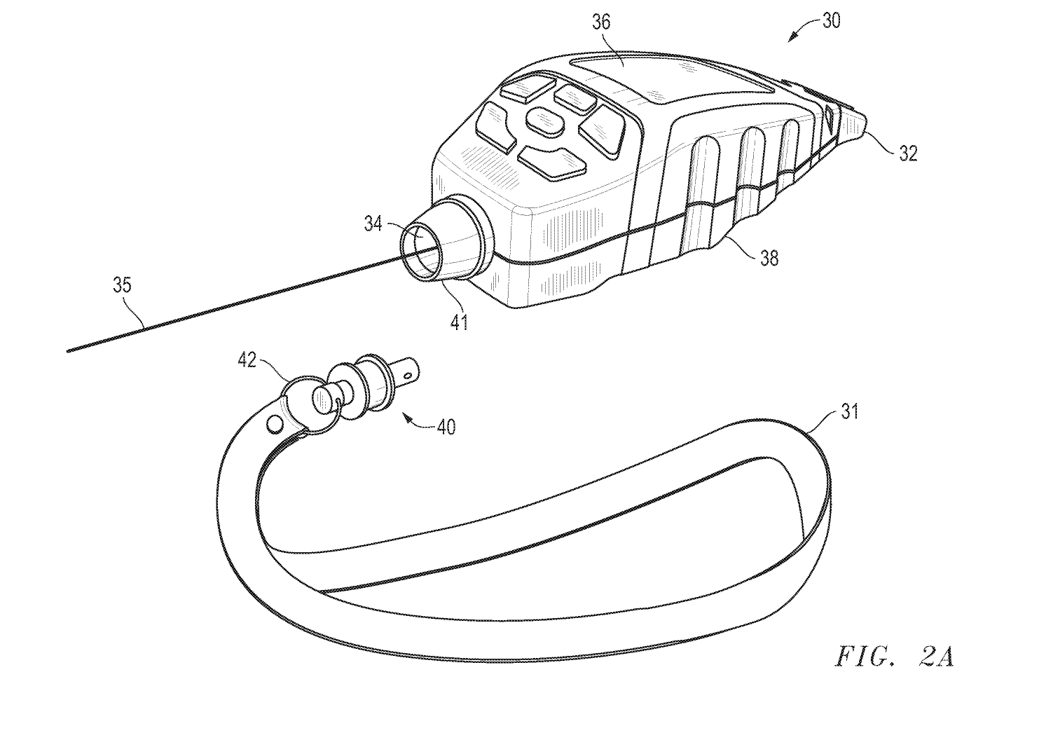

Referring now to FIG. 2A, the multifunction sports and recreation device 30 comprises a sports whistle 32, a laser pointer 34, shown projecting a laser beam 35, and a digital electronic multimode combination stopwatch, timer and heat index indicator 36, all within a housing 38, which is shown disconnected from a snap-in connector 40, which plugs into a receptacle 41 in the housing 38, and connects to a swivel ring 42, which connects directly to the measuring lanyard 31. In an alternate embodiment, the swivel ring 42 can connect by a quick disconnect clip (not shown) to the measuring lanyard 31.

Referring now to FIG. 2B, the multifunction sports and recreation device 30 is shown with the receptacle 41 connected to the snap-in connector 40, which in turn is connected to the swivel ring 42, which is connected to the measuring lanyard 31.

The size of the multifunction device 30 is relatively small, and therefore easily dropped, misplaced, or lost. Therefore, the lanyard 31 may have a quick disconnect clip (not shown) attached to one end of the lanyard 31. The clip can be removably attached to the swivel ring 42, made of stainless steel, or plated, to prevent rust. The swivel ring 42 may alternatively be a D-ring. The ring 42 and the disconnect clip may have one or more tether swivels, to allow the device to rotate in any direction and to avoid entanglements or twisting in the lanyard. Alternatively, the lanyard may have split O-rings, bulldog clips, swivel hooks, buckles, or stitched ends to fasten to the multifunction device 30.

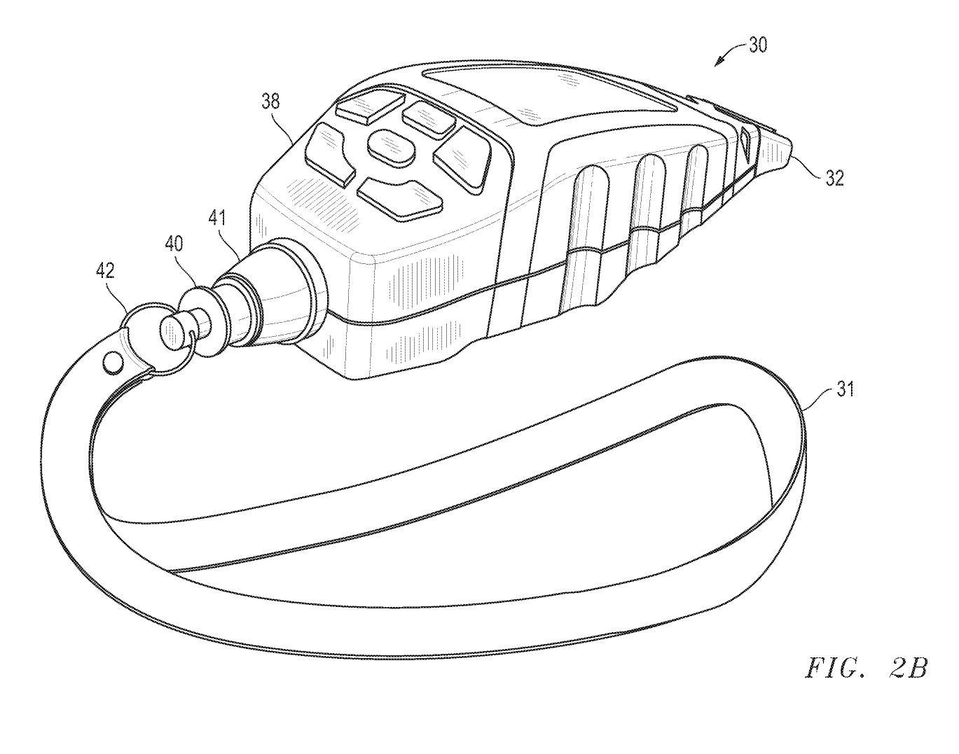

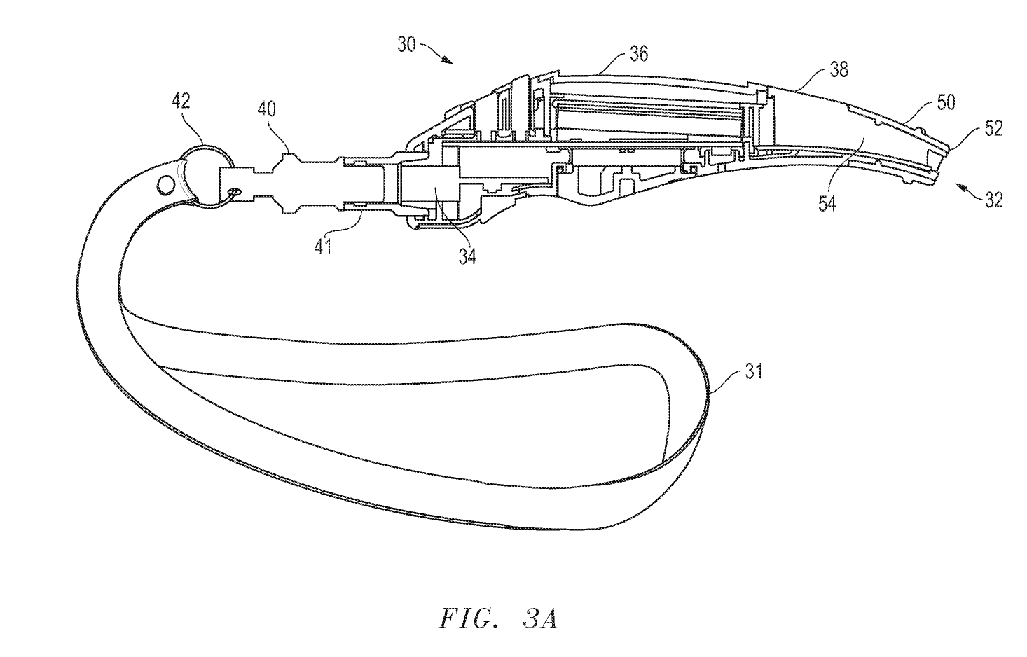

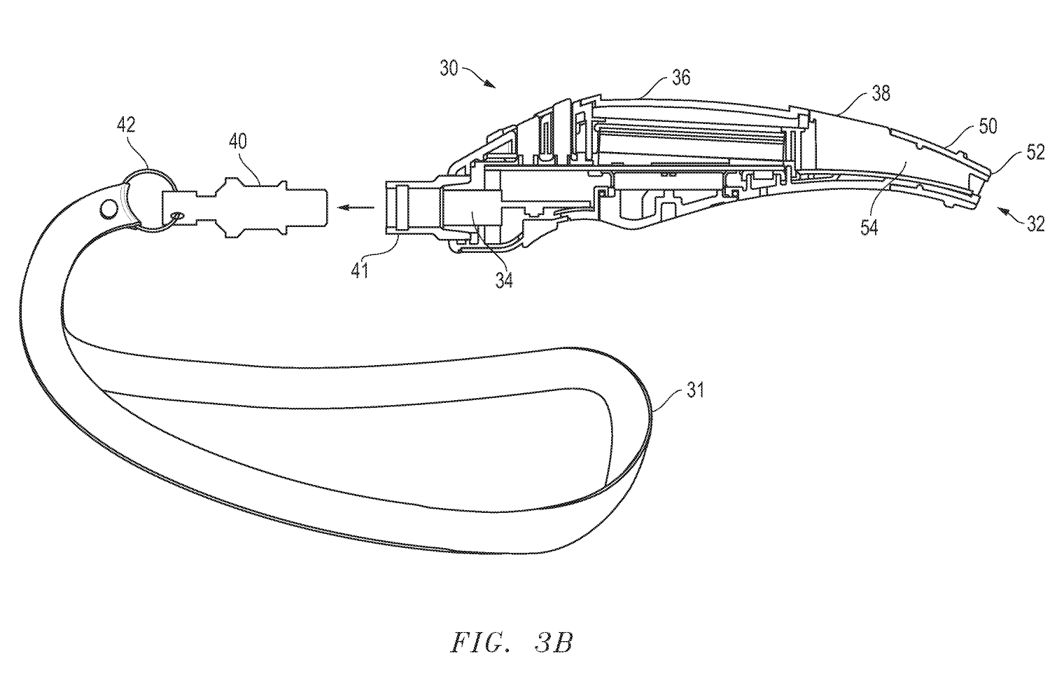

Referring now to FIGS. 3A and 3B, the whistle 32 has no ball or pea inside, but instead uses air directed from a replaceable rubber mouthpiece 50. The whistle 32 uses two offset fipple chambers of differing sizes that provide a high pitch resonant whistle when air is blown into the mouthpiece and then passes through each chamber separately, then out the aerodynamic chamfered openings 54 at each side. The whistle 32 produces a loud, high-pitched, complex tone that is clearly audible at least to the players, despite the high background noise that is present in many sports arenas.

The sports whistle 32 has a fipple flute design with multiple chambers made from Acrylonitrile butadiene styrene, also known as ABS, chemical formula CSHS.C4H6.C3H3Nn, is a common thermoplastic used to make light, rigid, molded products such as piping, automotive body parts, and toys including, LEGO bricks. As is known in the art, a fipple flute whistle consists of an assembly of a number of separate whistle chambers having air columns of different lengths, and therefore each chamber has a different fundamental frequency, all of which are blown simultaneously from a single mouthpiece in order to produce a more audible sound with greater volume.

The rubber mouthpiece 50 is formed to provide a structure around which a user's mouth may comfortably circumscribe to blow a steam of air into an edge opening 52 of the whistle 32, and to serve as a teeth guard. The mouthpiece 50 may be made of medium durable rubber material, molded in several different colors, and may include one or more colors for color contrast or highlighting purposes. Preferably, the mouthpiece 50 is formed from thermoplastic elastomer (“TPE”), sometimes referred to as thermoplastic rubber, which is a class of copolymers or a physical mix of polymers (usually a plastic and a rubber) which consist of materials with both thermoplastic and elastomeric properties. While most elastomers are thermosets, thermoplastics are in contrast relatively easy to use in manufacturing, for example, by injection molding. Replacement mouthpieces can be provided for sanitary reasons or to account for tom, chewed, or missing mouthpieces.

Referring now to FIGS. 4A and 4B, the lanyard 31 can be placed around the neck, arm, or other appendage of a user to reduce the occurrence of loss, and increase the carrying convenience to the user. The lanyard 31 is made of I6-20 mm soft woven nylon material, that can be made in different colors (black, blue, red, green, etc.) to meet a user's preference or to match a team's color preferences. Of course, any cord, rope, or other lanyard material may be used. As shown in FIG. 4A, the lanyard 31 includes one or more measurement lines and numbers woven in a contrasting color into the lanyard or added to the lanyard using dye sublimation. The measurement lines can be used by coaches to measure certain distances, such as splits between linemen in football, vertical leaps of players in basketball, and the like. While any measurement length can be used, the preferred line spacing is at I-inch increments on one side and 1-cm increments on the other side. Similarly, the lanyard itself can be of any length needed for the circumstances, and made of any material desired, including a neoprene lanyard that helps float the device in water.

In order to use the laser pointer 34, the snap-in connector 40 must first be disconnected from the housing 38. As is known in the art, generally laser pointers are portable, pen-sized, and designed to be held in the hand, most commonly used to project a point of light to highlight items of interest during a presentation.

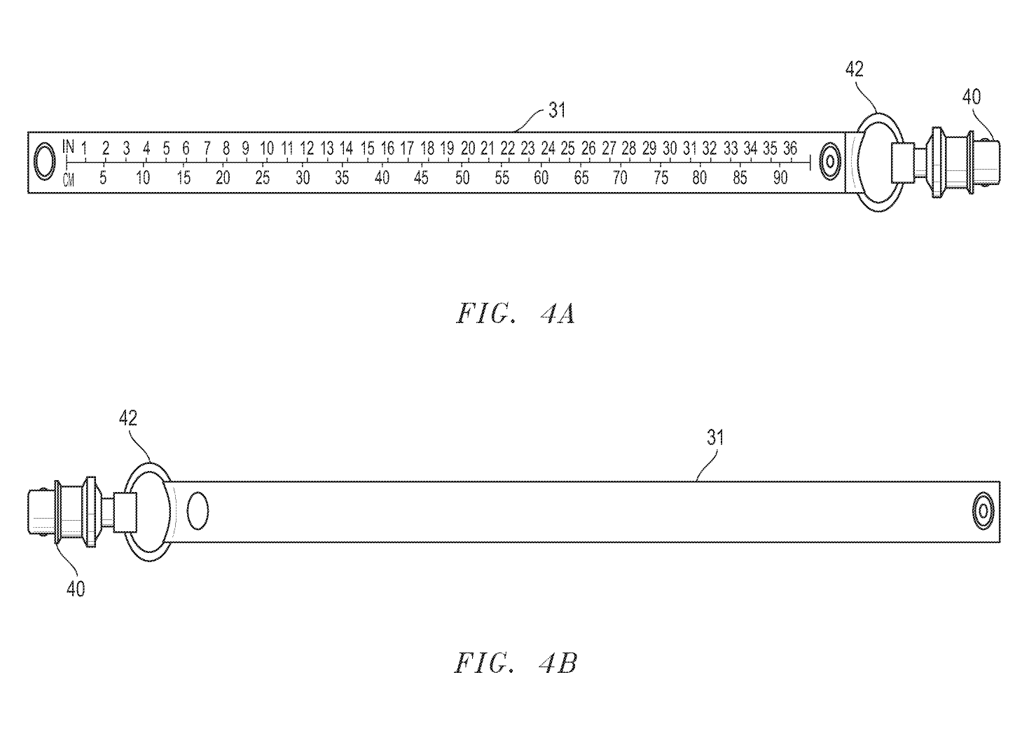

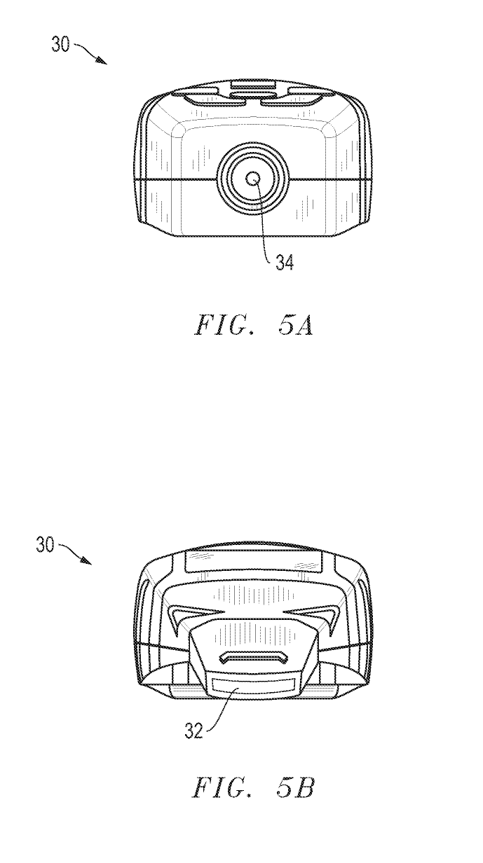

Referring now to FIGS. 5A and 5B, at one end of the housing 38 is the laser pointer 34, shown in FIG. 5A, and at the other end of the housing 38 is the whistle 32, shown in FIG. 5B.

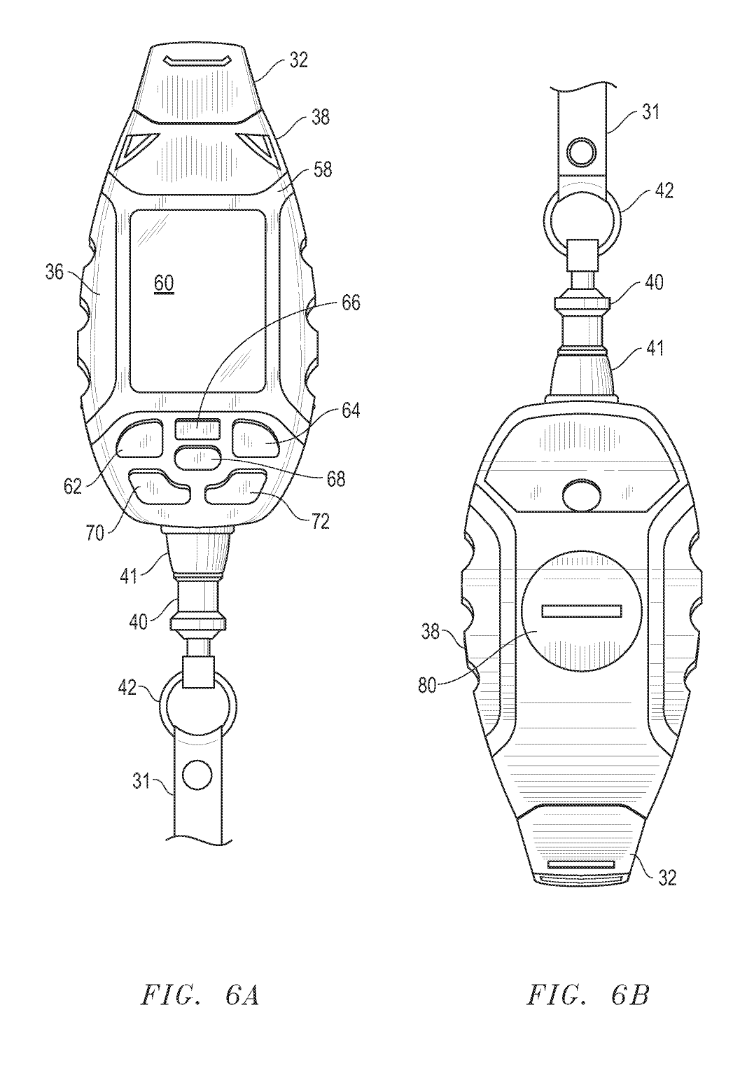

Referring now to FIG. 6A, the housing 38 contains the multimode combination stopwatch, timer, and heat index indicator 36, which includes a brace 58 which holds a protective cover 61 (shown in FIG. 7) over a liquid crystal display (“LCD”) screen 60. The protective cover 61 (shown in FIG. 7) can be made of any clear, scratch resistant material, but in the preferred embodiment it is a polycarbonate. The LCD screen 60 and its cover 61 are securely attached to the housing 38 by the brace 58, and sealed to prevent condensation build-up.

While LCD screens are preferred, LED screens, and traditional chronograph screens may be used in the present invention. Here, the LCD screen 60 features four lines of fourteen characters width, capable of multiple fonts and character sizes, capable of special characters such as for degrees of temperature, and is easy to see the display in sunlight and in low light conditions. The temperature/heat Index, DaylDate, and current time are visible on the primary screen.

The housing 38 also includes six operating buttons: up arrow 62, down arrow 64, light 66, program 68, set/reset 70, and chronograph lap/record 72, in order to select and operate the various functions of the multimode indicator 36.

Referring now to FIG. 6B, the housing 38 includes a battery access door 80 for replacing a battery 92 (shown in FIGS. 7 and 9) that powers the laser pointer 34 and the multimode indicator 36. In the preferred embodiment, the battery 92 is a round button 3V lithium cell type CR2032 battery.

Referring now to FIG. 7, this exploded view shows the housing 38 in its major sections, a top section 82, a button section 83, a bottom section 84, a PCB board 85, and side sections 86, 87, 88, and 89. The side sections are soft touch overmold. In the preferred embodiment, the housing sections 82 and 84 are two-shot injection molded plastic. The housing sections 82 and 84 are shock-proof and water tight, and are connected with screws 90, but may also be connected by any suitable fastening method, including, but not limited to, adhesive, glue, rivets, welding—including ultrasonic welding, heat stamping, screws, snaps, or other fasteners. The material used to form the housing sections is ABS and is UV stable, but the material can also be TPE, or HIPS (high impact polystyrene).

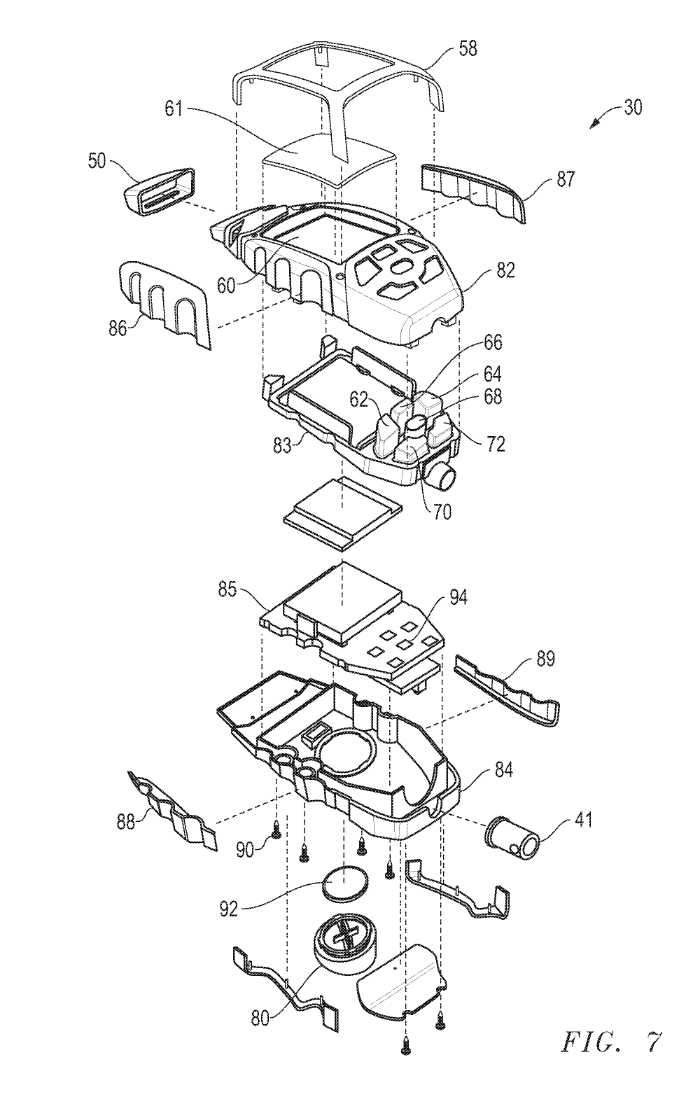

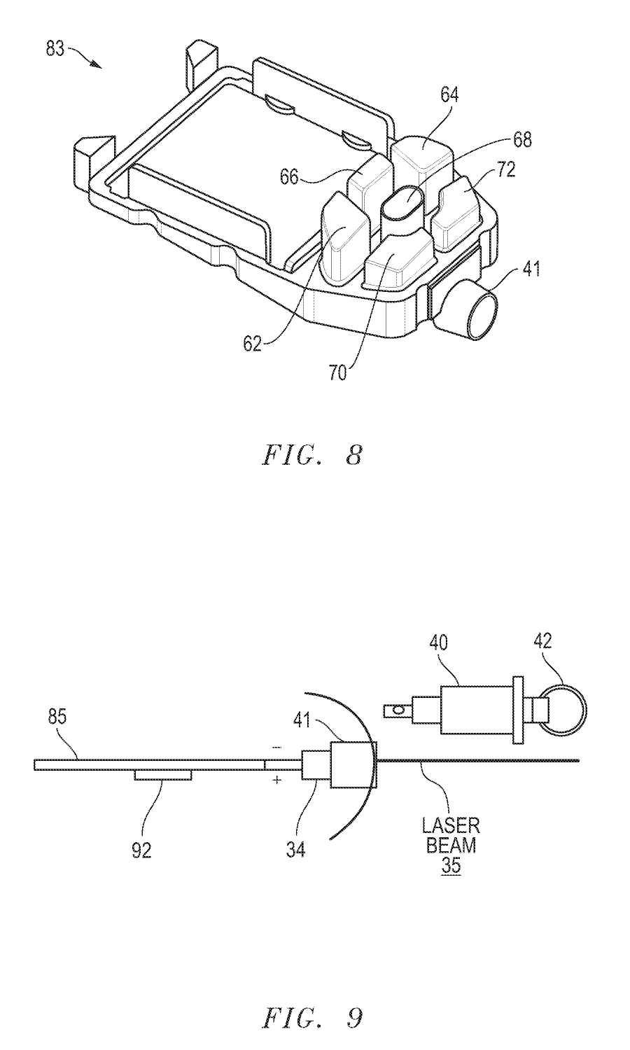

Referring now to FIG. 8, the operating buttons 62, 64, 66, 68, 70, and 72, have carbon fiber contacts on their bottom sides, which make contact with exposed contacts 94 (shown in FIG. 7) on the PCB 85. The operating buttons are made of conductive rubber construction, but may also be may of silicone, or clear ABS substructure with soft touch overmold. If desired, the buttons may be backlit for easier viewing at night, but in the preferred embodiment, there is no backlighting. Each button has a legend printed on the button, identifying that button's operating characteristics.

Referring now to FIG. 9, the PCB 85 utilizes standard stopwatch/thermometer circuits, and has a stiffener for supporting humidity and temperature sensors. The PCB 85 features a non-contact infrared dual readout thermometer circuit to indicate ambient temperature, to allow the stopwatch to display both temperature and heat index, which can be set to indicate Celsius or Fahrenheit, with the display being set to indicate the scale desired.

The multifunction device 30 is configured to emit several audible alarms from one or more thin piezoelectric speakers (not shown) on the PCB 85. As is known in the art, piezoelectric speakers are frequently used as beepers in watches and other electronic devices with output characteristics that can be tuned to the parameters of the application. For example, different 10 speaker sounds can indicate the following:

(a) Alarm time—Daily Alarm and Segment Alarm: series of three (3) short beeps repeating until user presses button to stop alarm;

(b) Start timing event—one (I) short beep;

(c) Stop timing event—two (2) short beeps; and

(d) Pre-set or Target Heat Index reached—10 second long beep, repeats until user presses button to stop alarm.

As such, the multifunction device 30 may further or alternatively comprise a user alarm for notifying the user when a particular heat index level is reached. The alarm may be audible, visible (with perhaps flashing lights), and/or may be vibrating. Preferably, this preset heat 20 index level can be set by the user. Alternatively, it can be fixed. The multifunction device 30 may further comprise a user alarm for notifying the user when a particular humidity and/or temperature is reached. The multifunction device 30 also displays on the LCD screen 60 the relative humidity and the ambient temperature.

The computation used for the heat index (“HI”) is preferably a refinement of a result obtained by multiple regression analysis carried out by Lans P. Rothfusz and described in a 5 1990 National Weather Service (NWS) Technical Attachment (SR 90-23). The regression equation of Rothfusz is:

HI=−42.379+2.04901523*T+I0.14333127*RH−0.22475541*T*RH−0.00683783*T*T−0.05−481717*RH*RH+0.00122874*T*T*RH+O0.00085282*T*RH*RH−0.00000199*T*T*RH*RH

where T is temperature in degrees F., and RH is relative humidity in percent. HI is the heat index expressed as an apparent temperature in degrees F. If the RH is less than 13%, and the temperature is between 80 and 112 degrees F., then the following adjustment is subtracted from HI:

ADJUSTMENT=[(13−RH)/4]*SQRT{[17−ABS(T−95.)]/17}

where ABS and SQRT are the absolute value and square root functions, respectively. On the other hand, if the RH is greater than 85% and the temperature is between 80 and 87 degrees F., then the following adjustment is added to HI:

ADJUSTMENT=[(RH−85)/10]*[(87−T)/5]

An alternate method is to refer to readily available tables listing the HI for specific temperatures and RH. The data from these tables can be stored in the memory of the instrument, for example in a look-up table that is used to determine the HI. These tables can also indicate to the user the severity of exposure to a specific HI. Sudden temperature and humidity changes (e.g. going indoors to outdoors) may cause inaccurate temperature, humidity, and heat index readings for up to 45 minutes.

In other embodiments, particularly those with an outdoor recreation influence, the multifunction device 30 may also include the following: a digital compass; radio frequency transmitters and receivers for locating a base camp; means for monitoring or indicating wind speed, barometric pressure, and lunar tide cycles; an outdoor light; and a fire-starting flint. In addition, the multifunction device 30 could incorporate Bluetooth technology, USB ports, and or other means for synchronizing the device to a personal computer, and also incorporate MP3 player capabilities.

Operation

The multimode indicator 36 includes the following features:
Stopwatch/chronograph mode with 1/100 second resolution
Fastest/Slowest/Average Lap recall
99 lap counter with 30 lap/split memory
10 hour countdown timer with audible beeper warning for the last 5 seconds
Programmable alarm
Calendar mode displays day, month, and date
12- or 24-hour clock operation
Stopwatch timing large characters at bottom on primary screen
Separate screens for programming and setting alarms

In normal operation, time is continuously being kept with hours and minutes information being simultaneously displayed on the visual display panel. The colon indicia, which separates the hours information from the minutes information is on for one second and off for one second as a running indicator for the watch. The watch has the following features:

Current time (12 hour and 24 hour format), indicate AM or PM

Day, date, month (SAT 23 ruN)

Alarms—Daily, Segmental, Heat Index

Single event timer—capable of timing to 100ths of a second

Multi-split timer

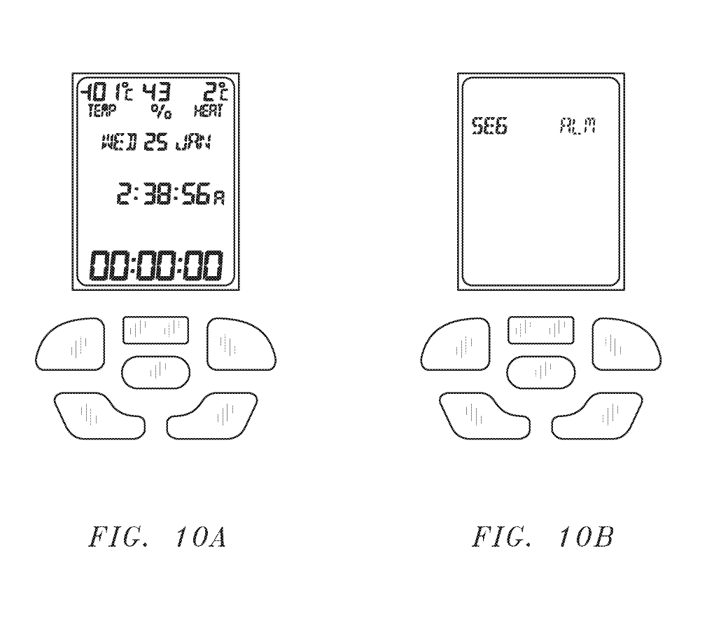

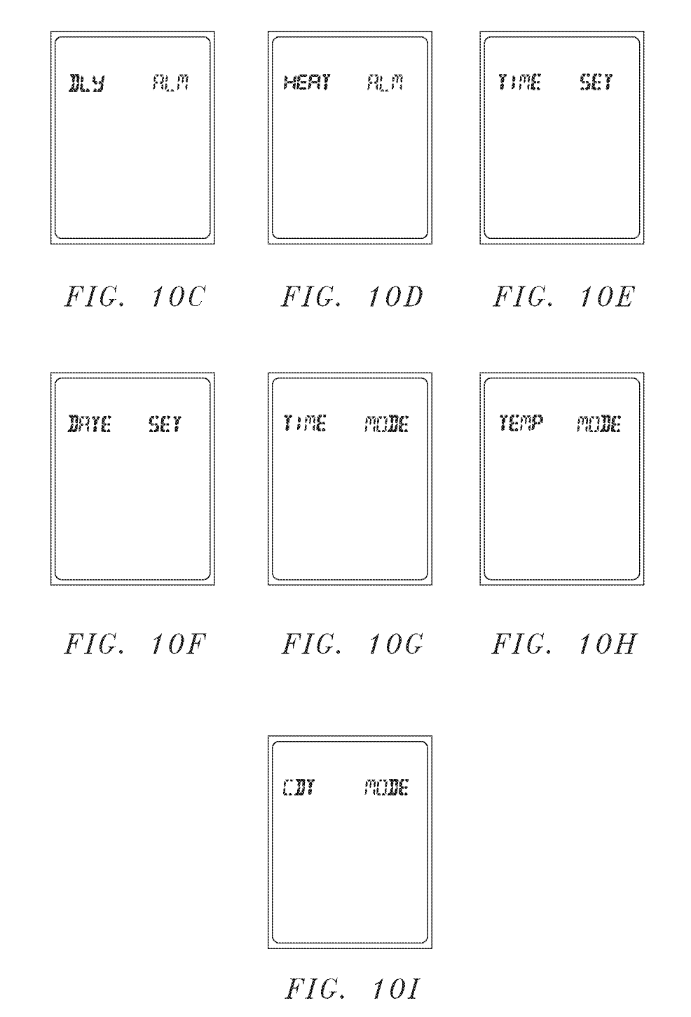

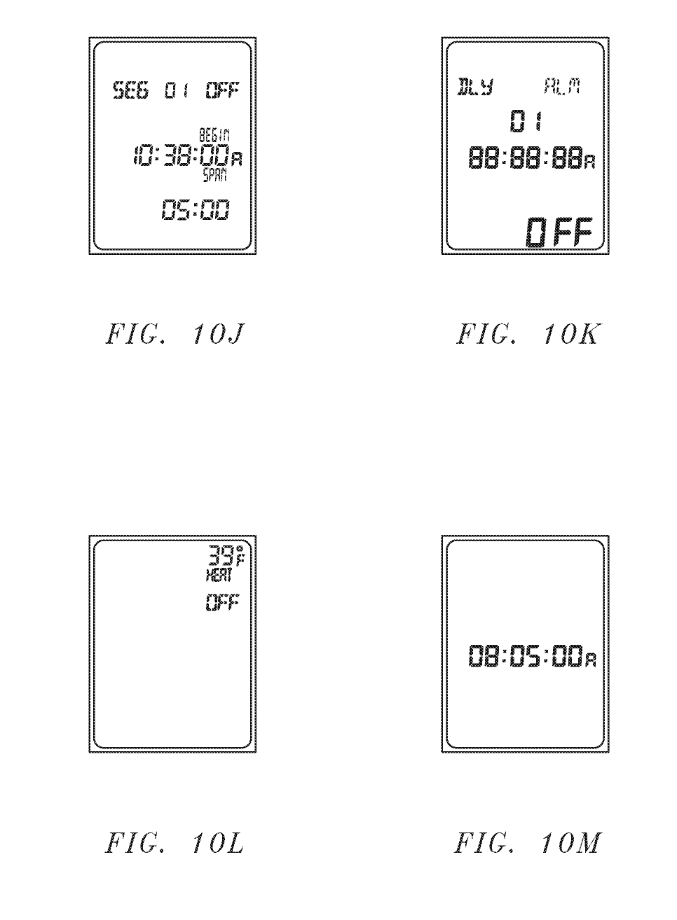

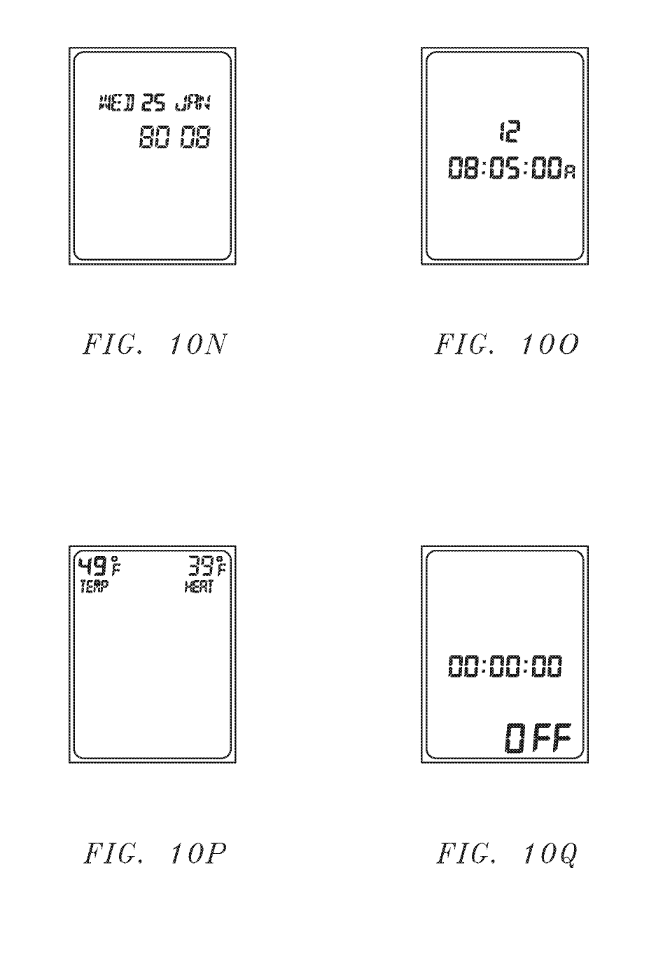

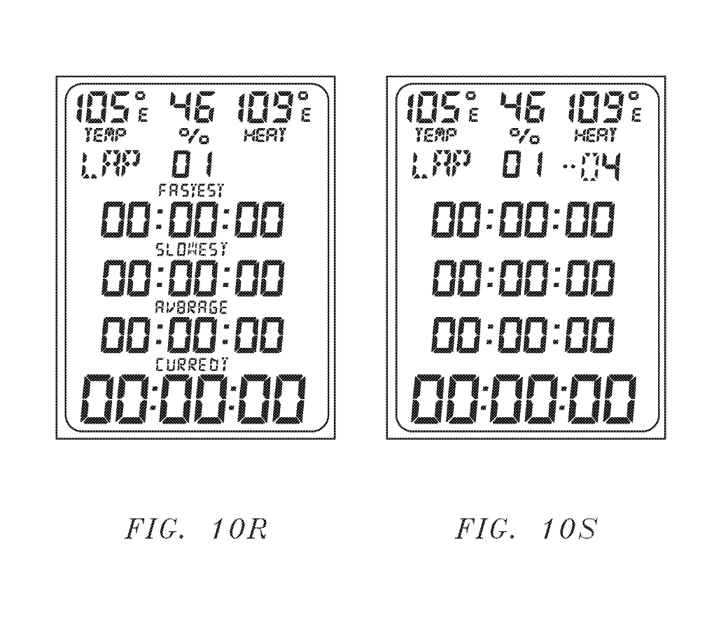

FIGS. 10A-10S show the different operating screens of the multimode indicator 36. Referring now to FIG. 10A, which shows the Main Screen,
1. To enter Program (Segment Alarm, Daily Alarms, Heat Alarm, Time Set, Date Set, Time Mode or Temp Mode) mode:
   Press and hold the PROG button for three (3) seconds
2. To enter Chronograph mode:
   Press and hold the CHRONO button for three (3) seconds
3. To time a single event:
   Press either the ▴ or ▾ button to start timing
   Press either the ▴ or ▾ button to stop timing
   To resume timing an event, press either button
   This cycle can be repeated indefinitely
4. To clear a single event:
   Press the SET/RESET button
5. To silence Segment and Daily alarms
   Press the PROG button once
6. When in Countdown Timer mode
   Press either the ▴ or ▾ button to start or stop timing

Referring now to FIGS. 10B-10I, which show the Program Mode Screens,
When first entering this screen, SEG ALM is blinking. Options to be programmed will scroll down in the following order when the ▴ button is pressed:
   SEG ALM
   DLY ALM
   HEAT ALM
   TIME SET
   DATE SET
   TIME MODE
   TEMP MODE
   CDT MODE
To scroll up through the list, press the ▾ button
   To set/change SEGMENTAL ALARMS:
   Press the SET button when SEG ALM is blinking
   To set/change DAILY ALARMS:
   Press the ▴ button until DLY ALM is blinking
   Press the SET button when DLY ALM is blinking
   To set/change HEAT ALARM:
   Press the ▴ button until HEAT ALM is blinking
   Press the SET button when HEAT ALM is blinking
   To set/change TIME:
   Press the ▴ button until TIME SET is blinking
   Press the SET button when TIME SET is blinking
   To set/change DATE:
   Press the ▴ button until DATE SET is blinking
   Press the SET button when DATE SET is blinking
   To set/change TIME MODE:
   Press the ▴ button until TIME MODE is blinking
   Press the SET button when TIME MODE is blinking
   To set/change TEMP MODE:
   Press the ▴ button until TEMP MODE is blinking
   Press the SET button when TEMP MODE is blinking
   To set/change CDT MODE:
   Press the ▴ button until CDT MODE is blinking
   Press the SET button when CDT MODE is blinking

Referring now to FIG. 10J, which shows the Segmental Alarms Program Screen,

When first entering this screen, SEGMENT 1 OFF is blinking
To turn alarm ON/OFF
Press the ▴ button a single time to change the value
Press SET to move to the BEGIN Hours
To change HOURS:
Press the ▴ button a single time to move forward
Press the ▾ button a single time to move back
Press the SET button to move to MINUTES
To set/change MINUTES:
Press the ▴ button a single time to move forward
Press the ▾ button a single time to move back
Press the SET button to move to AM/PM
To set/change AM/PM
NOTE: This setting is only available in 12 hour mode
Press the ▴ button a single time to change
Press the SET button to move to SEGMENT 1 SPAN
To change SEGMENT 1 SPAN: (NOTE: this function sets the duration of the segment)
Press the ▴ button a single time to advance the duration by 5 minute increments (Note: this can be a value of 0 minutes)
Press SET to program the next segment
NOTE: The BEGIN time of SEGMENT 2 defaults to the SEGMENT 1 BEGIN time plus the SPAN time.
Continue until all required SEGMENT ALARMS have been set/changed
The last segment to be programmed will have a span of 0 minutes. All subsequent segments will default to 0 minutes as well
To return to the Program Selection Screen
Press the PROG button

Referring now to FIG. 10K, which shows the Daily Alarm Screen,
To change Alarm #:
Press the ▴ button a single time to move forward
Press the ▾ button a single time to move back
Press the SET button to move to MINUTES
To change HOURS:
Press the ▴ button a single time to move forward
Press the ▾ button a single time to move back
Press the SET button to move to MINUTES
To set/change MINUTES:
Press the ▴ button a single time to move forward
Press the ▾ button a single time to move back
Press the SET button to move to AM/PM
To set/change AM/PM (only available when time is set to 12 hour mode)
Press the ▴ button a single time to change
Press the SET button to move to the next value
To turn alarm ON/OFF:
Press the ▴ button a single time to change
Press SET to move to the next Daily Alarm
To set the alarm and return to the Program Screen
Press the PROG button

Referring now to FIG. 10L, which shows the Heat Index Alarm Screen,
1. When scale changes to Celsius, a different formula is used to calculate Heat Index
2. Heat Index Alarm default alarm value will be pre-set to a maximum of 2° below the danger level)(106°). The user can set the alarm to be any value below this level within the valid range of the Heat Index.
3. When alarm value is reached, the alarm will be activated. The alarm must be different from all other alarms (rapid). Beep+blink for 20 seconds, blink only for 20 seconds, beep+blink for 20 seconds.
4. The heat index value will blink until it goes below the alarm value.
5. To set/change the HEAT INDEX alarm value:
1. Press the ▴ button to increase the value if value is below 106°
2. Press the ▾ button to decrease the value
6. To return to the Program Screen
1. Press the PROG button

Referring now to FIG. 10M, which shows the Time Set Screen,

1. To change HOURS:
Press the ▴ button a single time to move forward
Press the ▾ button a single time to move back
Press the SET button to move to MINUTES

2. To set/change MINUTES:
Press the ▴ button a single time to move forward
Press the ▾ button a single time to move back
Press the SET button to move to AM/PM

3. To set/change AM/PM (only available when in 12 hour mode):
Press the ▴ button a single time to change
Press the SET button to move to the next value

4. To return to the Program Screen
Press the PROG button

Referring now to FIG. 10N, which shows the Date Set Screen,
When first entering this screen, DAY is blinking. Each value will be highlighted (blinking) for setting/changing. NOTES: Holding down the ▴ or ▾ button will scroll quickly through the selected values. Day of week does not need to be set as it is calculated by year and day of month.
1. To set/change DATE:
   Press the ▴ button a single time to move forward one day
   Press the ▾ button a single time to move back one day
   Press the SET button to move to MONTH
2. To set/change MONTH:
   Press the ▴ button a single time to move forward one month
   Press the ▾ button a single time to move back one month
   Press the SET button to move to HOURS
3. To set/change YEAR:
   Press the ▴ button a single time to move forward one year
   Press the ▾ button a single time to move back one year
4. To return to the Program Screen
   Press the PROG button

Referring now to FIG. 10O, which shows the Time Mode Screen,

12 Hour format is blinking as the default setting
1. To change to 24 Hour format:
   Press the ▴ button
NOTE: All time values will reflect the setting on this screen (12 hour=2:30 pm, 24 hour=14:30)
2. To return to the Program Screen
   Press the PROG button

Referring now to FIG. 10P, which shows the, Temp Mode Screen,

° Fahrenheit is the default setting

To change to ° Celsius:
Press the ▴ button

NOTE: the temperature values will change when TEMP is changed

1. To return to the Program Screen
Press the PROG button

Referring now to FIG. 10Q, which shows the CDT (Countdown Timer) Mode Screen,

Countdown timer can be set for up to 99 minutes

1. To set the number of minutes:
Press the ▴ button to the desired duration

2. Press the SET button to move to the ON/OFF setting

3. To turn ON/OFF the countdown timer:
Press the ▴ button to change the value

4. To return to the Program Screen

Press the PROG button

Referring now to FIG. 10R, which shows the Chronograph mode,

The temp, humidity and heat index values will remain present.

1. Calculates the following each time a new lap is started:
Fastest (fastest stored lap; if only one lap has been timed, this will display the time for that lap)
Slowest (slowest stored lap; if only one lap has been timed, this will display the time for that lap)
Average (calculates the average time of the stored laps; if only one lap has been timed, this will display the time for that lap)

2. To start timing the first lap:
Press the ▴ button

3. To begin a new lap:
Press the LAP button

4. System will store up to 40 laps

5. To view the times of all stored laps
Press the ▾ button
Press the RECALL button to move to Lap Recall mode

6. To return to the Main Screen
Press the PROG button

Notes:

1. Lap values remain intact when switching between screens.

2. To clear all laps, press the RESET button for 3 seconds.

Referring now to FIG. 10S, which shows the Lap Recall mode,

1. Displays four stored laps at a time. To scroll through stored laps:
Press the ▴ button to move down the list (the list will index up in groups of 4 laps)
Press the ▾ button to move up the list (the list will index down in groups of 4 laps)
To clear all stored laps:
Press the RESET button for three (3) seconds

2. To return to the Main Screen
Press the PROG button

1. A multifunction sports and recreation device comprising:
(a) a sports whistle;
(b) a detachable measuring lanyard;
(c) a laser pointer; and
(d) a multimode digital electronic stopwatch.

2. The device of claim 1, wherein the stopwatch displays date, time, and advanced stopwatch information.

3. The device of claim 1, wherein the stopwatch displays temperature, relative humidity, and heat index information.

4. The device of claim 1 further comprising:
a. a digital compass;
b. radio frequency transmitters and receivers for locating a base camp; and
c. means for monitoring or indicating wind speed, barometric pressure, and lunar tide cycles.

5. The device of claim 1, further comprising an outdoor light.

6. The device of claim 1, further comprising a fire-starting flint.

7. A multifunction sports and recreation device comprising:
(a) a sports whistle;
(b) a detachable measuring lanyard;
(c) a laser pointer;
(d) a multimode digital electronic stopwatch, wherein the stopwatch displays: date, time, advanced stopwatch information, temperature, relative humidity, and heat index information;
(e) a digital compass;
(f) radio frequency transmitters and receivers for locating a base camp;
(g) means for monitoring or indicating wind speed, barometric pressure, and lunar tide cycles;
(h) an outdoor light; and
(i) a fire-starting flint.
